(19) United States
(12) Patent Application Publication
(10) Pub. No.: US 2015/0036369 A1
(43) Pub. Date: Feb. 5, 2015

(54) AUTOMOBILE LED HEAD LAMP MODULE USING FLEXIBLE SUBSTRATE AND HEAT SINK STRUCTURE THEREOF

(71) Applicant: LED FOLIO CORPORATION, Beverly Hills, CA (US)

(72) Inventor: Steven KIM, Fort Lee, NJ (US)

(73) Assignee: LED FOLIO CORPORATION, Beverly Hills, CA (US)

(21) Appl. No.: 14/100,396

(22) Filed: Dec. 9, 2013

(30) Foreign Application Priority Data
Aug. 2, 2013 (KR) 10201391931

(51) Int. Cl. F21S 8/10

(52) U.S. Cl. CPC F21S 48/321
USPC 362/487

(57) ABSTRACT

An LED automobile headlamp assembly including: a transparent front window; a back side housing attached to the transparent front window; a flexible heat spreader pad attached to the back housing and positioned between the back side housing and the front transparent window; an LED mounted on the heat spreader pad; and a supporting mechanism attached to the flexible heat spreader pad for tilting the LED.

This invention claims the benefit of Korean Patent Application No. 10-2013-091931 filed in Korea on Aug. 2, 2013, which is hereby incorporated by reference in its entirety.

### BACKGROUND OF THE INVENTION

1. Field Of The Invention

Embodiments of the invention relate to a structure and design of LED head lamp module for an automobile. Although embodiments of the invention are suitable for a wide scope of applications, it is particularly suitable for an LED head lamp module having improved heat dissipation such that, the lifetime and performance of LED can be enhanced.

2. Discussion Of The Related Art

In general, an automobile head lamp can be made using a conventional incandescent lamp or recently, an LED. The head lamp assembly is almost an air tight structure to prevent the introduction of dirt and humidity from the outside. Since the assembly housing has little air ventilation, the temperature inside of the assembly housing is normally more than 100 deg. C. The conventional metal halide or halogen lamp is not affected by the temperature. In contrast, the lifetime and performance of an LED is critically dependent on a reduced operating temperature. The lifetime of LED is decreased to less than 50% when the LED is used at 100 deg. C as compared to operating at 25 deg. C.

FIG. 1 shows the automobile head lamp assembly housing. FIG. 2 shows the structure of the automobile head lamp assembly consisting of (a) lens assembly including a transparent front window, reflector and other parts, (b) the lamp holder which can be tilted in x-y direction, and (c) back cover assembly which shows the almost air tight structure. The electrical connection or replacement of the lamp can be done using an air tight entry 42.

FIGS. 3a and 3b are illustrations of an LED automobile head lamp assembly. FIG. 3a shows the front view of an LED head lamp assembly, which is a somewhat airtight structure. FIG. 3b shows the back side of an LED head lamp assembly. An aluminum heatsink is mounted at the rear of the LED head lamp assembly and cooled by a fan. The entire LED head lamp assembly has to be tilted to direct the light of the LED.

FIG. 4 is an illustration of an LED module used inside of an LED automobile head lamp assembly using a fan and an aluminum heatsink. FIG. 4 shows that the aluminum heat sink is cooled by a fan mounted to the module. Even though a fan is used within the housing of an LED automobile head lamp assembly, the temperature inside of the assembly housing goes up to about 100 deg. C since there is no air ventilation but rather just a spreading of the heat within the assembly housing. The reason that an aluminum heat sink of an LED module cannot be located at outside of the assembly is that it is desirable for the LED module to have x-y direction tilting capability within the assembly housing. Also, using the fan inside of the assembly housing is not desirable because the fan can fail within the lifetime of the automobile and repair may require total replacement of all parts since the module is sealed within the assembly housing.

### SUMMARY OF THE INVENTION

Accordingly, embodiments of the invention are directed to an automobile LED head lamp module that substantially obviates one or more of the problems due to limitations and disadvantages of the related art.

An object of embodiments of the invention is to provide heat dissipation of the automobile LED head lamp module for higher lifetime and better performance of LED.

Another object of embodiments of the invention is to provide heat dissipation of the automobile LED head lamp module without a fan inside of the assembly.

Another object of embodiments of the invention is to provide a flexible heat spreader to enable the heat sink located outside of the module.

Another object of embodiments of the invention is to enable the LED module of the automobile LED head lamp module to have a tilt movement capability.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, the LED automobile headlamp assembly includes: a transparent front window; a back side housing attached to the transparent front window; a flexible heat spreader pad attached to the back housing and positioned between the back side housing and the front transparent window; an LED mounted on the heat spreader pad; and a supporting mechanism attached to the flexible heat spreader pad for tilting the LED.

In another aspect, the LED automobile headlamp assembly includes: a transparent front window; a back side housing attached to the transparent front window; a flexible heat spreader pad positioned between the back side housing and the front transparent window; an LED mounted on the heat spreader pad; and a heat sink mounted on the back side housing, wherein the flexible heat spreader pad is connected through the back side housing to the heat sink.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 shows an automobile head lamp assembly.

FIGS. 2a-2c show parts of the automobile head lamp assembly.

FIGS. 3a and 3b are illustrations of an LED automobile head lamp assembly at a front view and a back view, respectively.

FIG. 4 is an illustration of an LED module used inside of an LED automobile head lamp assembly using a fan and an aluminum heatsink.

FIG. 5 is a schematic diagram of the LED automobile head lamp using a U-shaped flexible heat conduction medium to a heatsink.

FIG. 6 is a schematic diagram of a flexible printed circuit board using a heat spreader pad.

FIGS. 7a and 7b show configurations of the flexible heat spreader pad.

FIG. 8 shows the tilting movement capability of the flexible printed circuit board in x-y direction.

FIG. 9 is a schematic diagram of an LED automobile head lamp using a L shaped flexible heat spreader pad.

FIG. 10 is a schematic diagram of the LED automobile head lamp showing the aluminum heat sink located outside of the assembly is cooled by a fan or air convention.

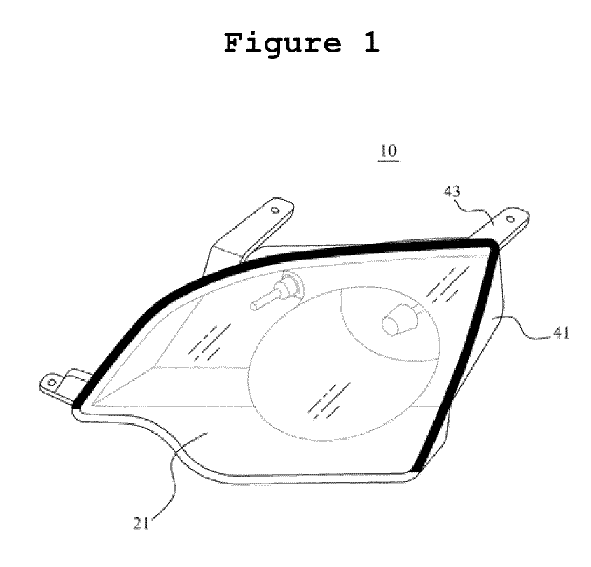

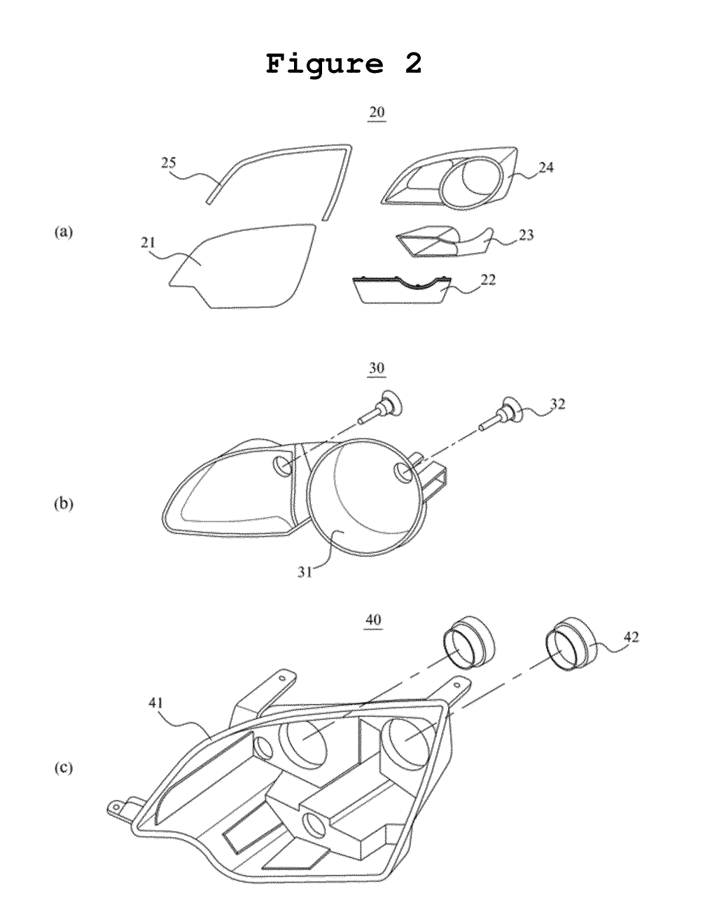

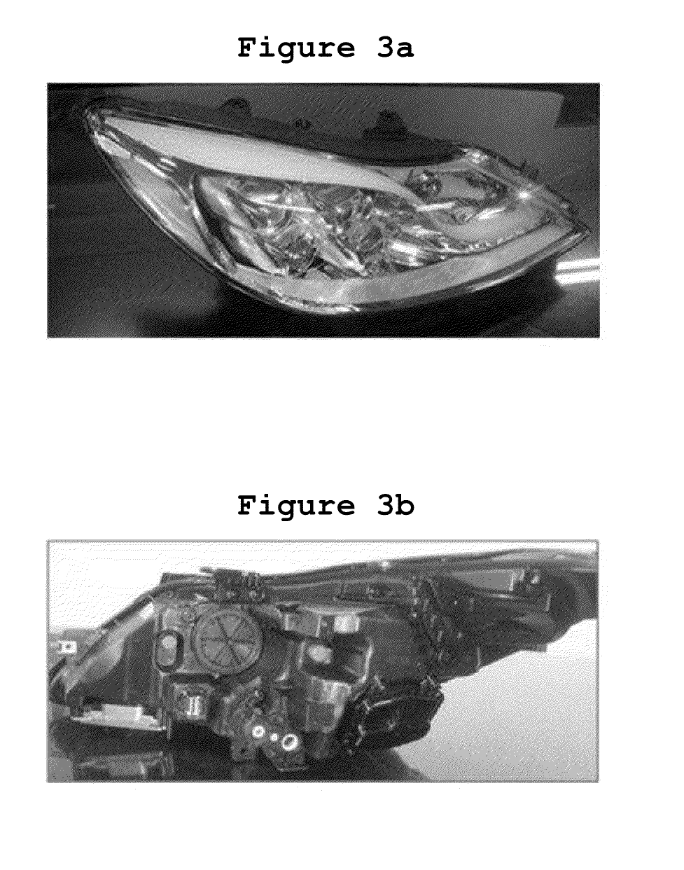

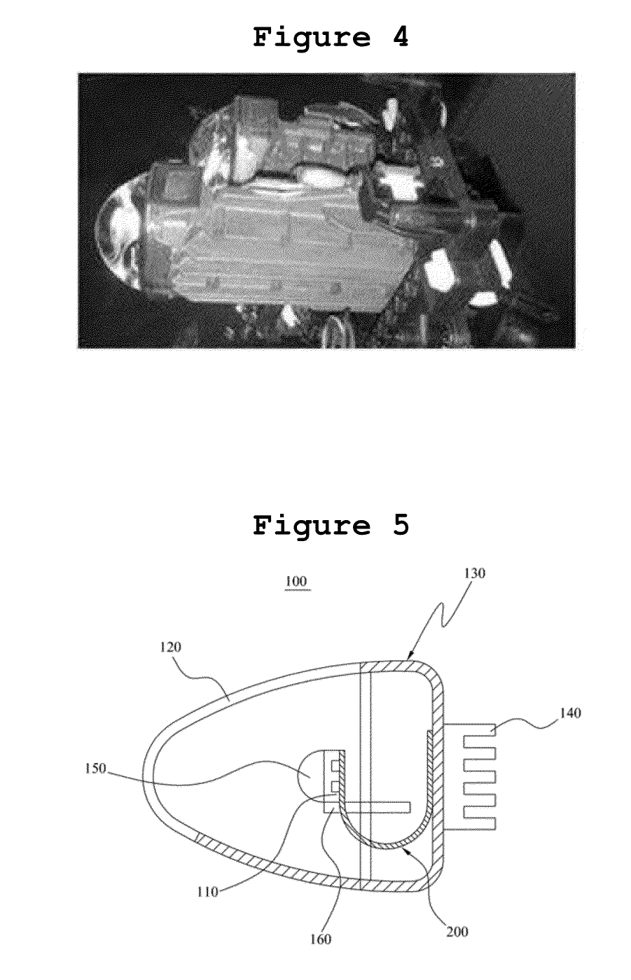

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

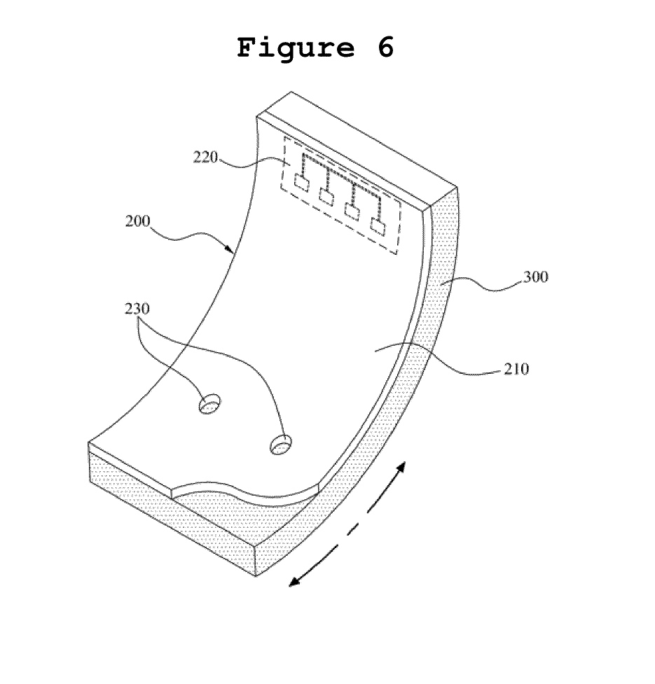

FIG. 5 is a schematic diagram of the LED automobile head lamp using a U-shaped flexible heat conduction medium to a heatsink. As shown in FIG. 5, an LED automobile head lamp assembly 100 uses a flexible heat spreader pad 200. LED automobile head lamp assembly 100 includes: a front transparent window 120, a back side housing 130 attached to the front transparent window 120, a flexible heat spreader pad 200 between the back side housing 130 and the front transparent window 120, LED 110 mounted directly on the flexible heat spreader pad 200, optics 150 for the LED 110 and a supporting mechanism 160 attached to the flexible heat spreader pad 200 for tilting the LED. A heat sink 140 mounted on the back side housing 130. The flexible heat spreader pad 200 is connected through the back side housing 130 to the heat sink 140 located outside of the assembly housing, which is the back side housing 130 attached to the front transparent window 120.

The heat generated by LED 110 is transferred through the heat spreader pad 200 such that the heat is dissipated to outside by the heat sink located outside of the back side housing 130. A direct heat conductive connect is made between heat spreader pad 200 and the heat sink 140. The LED 110 can be either a single LED chip or a chip-on-board LED, which can be an array of LEDs, is mounted on the flexible heat spreader pad 200.

Because a flexible heat conductive material is used transfer heat generated by LED to a heatsink located at outside of the assembly, an x-y tilt movement capability can be provided for the LED. That is, the LED chip or Chip-On-Board LED is made on the heat spreader pad and the other end of the heat spreader pad is mounted at the back side housing and attached to the heat sink outside of the assembly. Thus, a fan inside of the housing is not needed. The heat generated by the LED can be efficiently removed to outside of the assembly housing, which makes a lower temperature within the assembly housing such that the lifetime and performance of LED can be enhanced. Also, by eliminating the fan inside of the assembly housing, the maintenance of the automobile head lamp is easier and less costly.

FIG. 6 is a schematic diagram of a flexible printed circuit board using a heat spreader pad. As shown in FIG. 6, the flexible heat spreader pad 200 has a supporting metal foil 210. The metal foil 210 provides a mechanical reliability over the tilting movement range of the LED because the heat spreader material 300 alone by itself would be fragile. The metal foil 210 can be copper. On top of the metal foil 210, electric circuit 220 can be made by adding dielectric layer onto the metal foil 210. The electric circuit 220 is used for connecting the LED to the heat spreader pad 200. The bolt hole 230 can be made on the flexible heat spreading pad 200 so the aluminum heat sink directly attached to by a bolt-and-nut connection, which provides a good thermal contact between the flexible heat spreader pad 200 and the aluminum heat sink.

The heat spreader material 300 can be a composite made of graphite and nano-metal powder, such as graphene with nano-metal particles. In the alternative, the heat spreader material 300 can be just artificial graphite, such as just graphene. The thermal conductivity of the heat spreader material 300 can be greater than 500 W/mK in a planar direction and about 5 W/mK in a vertical direction.

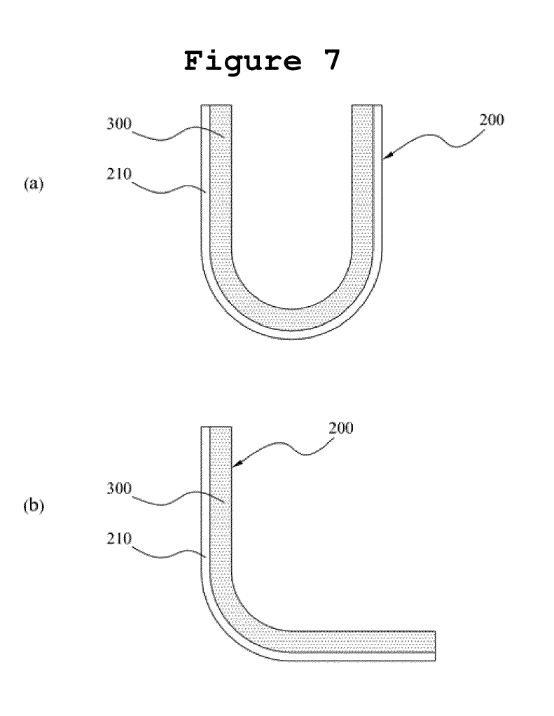

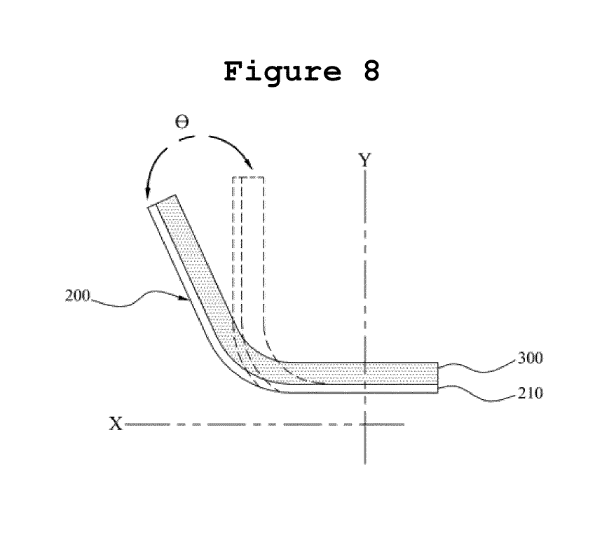

FIGS. 7a and 7b show configurations of the flexible heat spreader pad. As shown in FIG. 7a, the flexible heat spreader pad 200 can be “U” shaped. As shown in FIG. 7b the flexible heat spreader pad 200 can be “L” shaped. FIG. 8 shows the tilting movement capability of the flexible printed circuit board in x-y direction. As shown in FIG. 8, the bends in the flexible heat spreader pad 200 enable an x-y tilting movement capability of up to 40 degree.

The heat spreader material has a unique property of thermal conduction in that the planar conductivity is greater than 500 W/mK and the vertical conductivity is of about 5 W/mK. The typical thickness of the heat spreading pad is of about 50 um, including the metal foil. A heat spreader sheet is well described at Martin Smalc et al. “Thermal performance of Natural Graphite Heat Spreader”. The planar thermal conductivity of the heat spreading pad is higher than that of copper, which is about 388 W/mK. Thus, the heat spreading pad can transfer the heat efficiently and in the same time it accommodates the tilting requirement for the automobile head lamp.

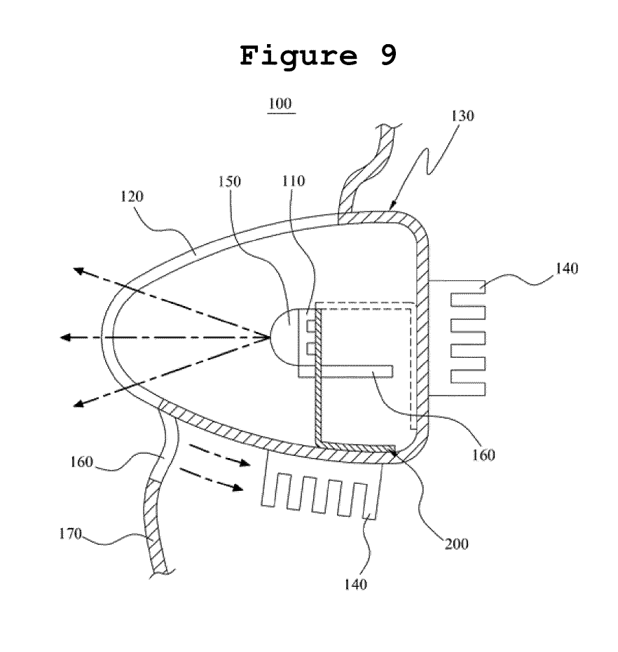

FIG. 9 is a schematic diagram of an LED automobile head lamp using an L shaped flexible heat spreader pad. Further, FIG. 9 shows how the heat sink can be cooled. That is, air from outside of the automobile can be introduced through a small vent hole 190 such that air flow from the front of the automobile can dissipate heat from the heat sink 140.

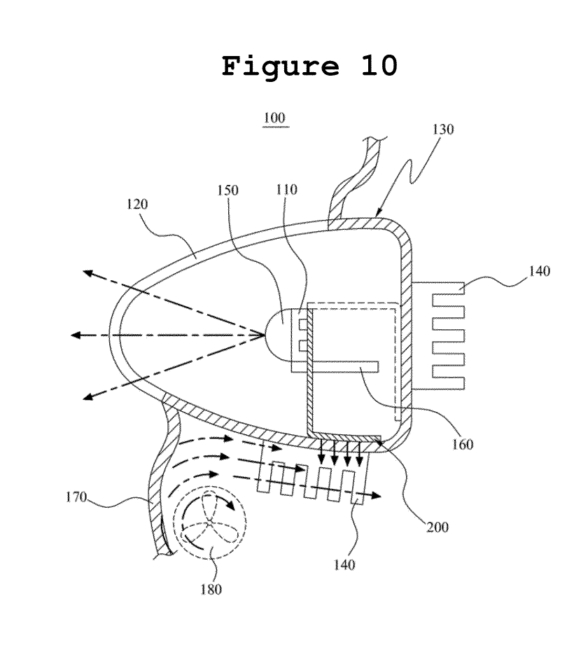

FIG. 10 is a schematic diagram of the LED automobile head lamp showing the aluminum heat sink located outside of the assembly is cooled by a fan or air convention. As shown in FIG. 10, an external fan 180 can be used to dissipate the heat sink 140. Unlike a fan inside of the headlamp assembly housing, the external fan 180 outside can be easily maintained.

It will be apparent to those skilled in the art that various modifications and variations can be made in the LED head lamp module of embodiments of the invention without departing from the spirit or scope of the invention. Thus, it is intended that embodiments of the invention cover the modifications and variations of this invention provided they come within the scope of the appended claims and their equivalents.

What is claimed is:

1. An LED automobile headlamp assembly, comprising:
a transparent front window;
a back side housing attached to the transparent front window;
a flexible heat spreader pad attached to the back housing and positioned between the back side housing and the front transparent window;
an LED mounted on the heat spreader pad; and
a supporting mechanism attached to the flexible heat spreader pad for tilting the LED.

2. The LED automobile headlamp assembly according to claim 1, wherein the flexible heat spreader pad comprises a layer of heat spreader material and a metal foil on the heat spreader material.

3. The LED automobile headlamp assembly according to claim 2, wherein the metal foil is copper.

4. The LED automobile headlamp assembly according to claim 2, wherein the heat spreader material has a planar conductivity greater than 500 W/mK.

5. The LED automobile headlamp assembly according to claim 2, wherein the heat spreader material is graphite.

6. The LED automobile headlamp assembly according to claim 2, wherein the heat spreader material is made of carbon and metal.

7. The LED automobile headlamp assembly according to claim 1, wherein a thickness of the flexible heat spreading pad has a thickness of about 50 um.

8. The LED automobile headlamp assembly according to claim 1, wherein the flexible heat spreading pad has an “L” shape.

9. The LED automobile headlamp assembly according to claim 1, wherein the flexible heat spreading pad has a “U” shape.

10. The LED automobile headlamp assembly according to claim 1, further comprising an electric circuit on the heat spreader pad for connecting to the LED.

11. An LED automobile headlamp assembly, comprising:
a transparent front window;
a back side housing attached to the transparent front window;
a flexible heat spreader pad positioned between the back side housing and the front transparent window;
an LED mounted on the heat spreader pad; and
a heat sink mounted on the back side housing,
wherein the flexible heat spreader pad is connected through the back side housing to the heat sink.

12. The LED automobile headlamp assembly according to claim 11, wherein the flexible heat spreader pad comprises a layer of heat spreader material and a metal foil on the heat spreader material.

13. The LED automobile headlamp assembly according to claim 12, wherein the metal foil is copper.

14. The LED automobile headlamp assembly according to claim 12, wherein the heat spreader material has a planar conductivity greater than 500 W/mK.

15. The LED automobile headlamp assembly according to claim 12, wherein the heat spreader material is graphite.

16. The LED automobile headlamp assembly according to claim 12, wherein the heat spreader material is made of carbon and metal.

17. The LED automobile headlamp assembly according to claim 11, wherein a thickness of the flexible heat spreading pad has a thickness of about 50 um.

18. The LED automobile headlamp assembly according to claim 11, wherein the flexible heat spreading pad has an “L” shape.

19. The LED automobile headlamp assembly according to claim 11, wherein the flexible heat spreading pad has a “U” shape.

20. The LED automobile headlamp assembly according to claim 11, further comprising an electric circuit on the heat spreader pad for connecting to the LED.
